(19) United States
(12) Patent Application Publication
(10) Pub. No.: US 2005/0138389 A1
(43) Pub. Date: Jun. 23, 2005

(54) System and method for making password token portable in trusted platform module (TPM)

(75) Inventors: Ryan Charles Catherman, Raleigh, NC (US); David Carroll Challener, Raleigh, NC (US); John Hancock Nicholson III, Durham, NC (US)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY (US)

(21) Appl. No.: 10/744,444

(22) Filed: Dec. 23, 2003

(51) Int. Cl. H04L 9/32; G06F 11/30

(52) U.S. Cl. 713/185; 713/202

(57) ABSTRACT

A computing device includes an application such as Lotus® Notes® requiring log on data to access. A trusted platform module (TPM) can hold the log on data. A software-implemented shim is interposed between the application and security module to appear to function as the application or the security module for providing a means for migrating the token if desired by a user.

### I. FIELD OF THE INVENTION

The present invention relates generally to secure computing devices.

### II. BACKGROUND OF THE INVENTION

Trust has become an important issue for e-commerce and other applications, particularly for mobile computing devices such as notebook computers. Specifically, as the mobility of the computing platform increases, it becomes susceptible to theft, with stolen data often representing a bigger loss than the hardware itself, because the data can include, e.g., user identity information, credit card information, and so on.

With this in mind, the Trusted Computing Platform Alliance (TCPA) has been formed to develop a specification for a trusted computing platform. Using a hardware security module (actually, a microcontroller) known as the Trusted Platform Module (TPM) that is soldered to the motherboard of the computing platform, the TCPA establishes what can be thought of as a platform root of trust that uniquely identifies a particular platform and that provides various cryptographic capabilities including hardware-protected storage, digital certificates, IKE (Internet Key Exchange), PKI (Public Key Infrastructure), and so on. Essentially, to overcome the vulnerability of storing encryption keys, authentication certificates, and the like on a hard disk drive, which might be removed or otherwise accessed or tampered with by unauthorized people, encryption keys, certificates, and other sensitive data is stored on the secure TPM.

The various keys including the endorsement keys are unique to the TPM. The keys can be used to in turn encrypt other keys for various purposes, thereby extending the trust boundary as desired. The validity of the endorsement keys is attested to by an electronic document known as an endorsement certificate that is provided by someone other than the entity that provides the keys and that is generated using the TPM public half of the endorsement key.

Various applications run by the customer device processor may desire to use the TPM in various ways. For example, Lotus® Notes®), which can generate a random number untypable password to gain entry to a user ID file for logging onto a Notes network, may otherwise want to have the TPM encrypt and store the password. Currently, Lotus Notes uses a removable SmartCard® for this purpose. The password is pushed onto the PKCS #11 stack of the SmartCard, and the ID file on the system server is re-encrypted with the password (or something derived from it by encryption techniques) so that the only way to log onto the system is through the new, encrypted ID file using the password on the Smartcard.

As recognized by the present invention, however, a SmartCard is removable from a host computer but a TPM is not. Consequently, if a program like Lotus Notes uses a TPM to encrypt and store its password for log on purposes, the user can log onto the network only from the platform that hosts the TPM. Among other ramifications, this means that the user cannot upgrade the host system or log on to the application from other platforms, which severely detracts from the usefulness of a TPM under these circumstances. The problem is complicated by the fact that an application such as Notes may not necessarily indicate that the data it is passing is a password, and that the source code of the application may not be accessible or for some other reason amenable to alteration to so indicate that a password is being transmitted. Accordingly, the present invention recognizes a need to permit a TPM to function as an encryption and storage module for application-specific passwords and still provide portability of the password token without altering the source code of the application.

### SUMMARY OF THE INVENTION

A method for promoting the portability of a token includes establishing a shim that is a surrogate of a security module which is not removable from a customer computing device. The method also includes receiving, at the shim, data intended for the security module, with the data being recorded at the shim and passed on to the security module. At the shim, the data is encrypted with a random number to render at least a portion of a blob, and then the blob is stored on a storage device that is external to the security module.

Preferably, the method includes encrypting the random number with a key generated using the password. The method may also include decrypting the blob and passing it to the security module when it is desired to migrate at least one of: the key, the random number, and the password, from the security module to another location. The security module may be a trusted platform module (TPM).

In another aspect, a customer computing device includes an application requiring use of a token to log on to an application network, and a permanently mounted security module possessing the token to allow a user of the customer computing device to log on to the network. A software-implemented shim that represents the application or the security module is positioned in a communication path between the application and security module. The shim facilitates migration of the token from the security module under predefined conditions.

In yet another aspect, in a system that includes an application requiring use of a token to log on to an application network and a permanently mounted security module possessing the token to allow a user to log on to the network, a method is disclosed for promoting the portability of the token. The method includes providing a shim that is a surrogate of the application, with the shim receiving from the security module a password and encrypting a data blob with the password and sending the blob to the application.

In still another aspect, a computing device includes an application requiring log on data to access, a permanently mounted security module holding the log on data, and a shim interposed between the application and security module to appear to function as the application or the security module for providing a means for migrating the token if desired by a user.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of the present architecture;

FIG. 2 is a flow chart of a first embodiment of the presently preferred logic; and

FIG. 3 is a flow chart of a second embodiment of the presently preferred logic.

### DETAILED DESCRIPTION OF THE PREFERRED EMBODIMENT

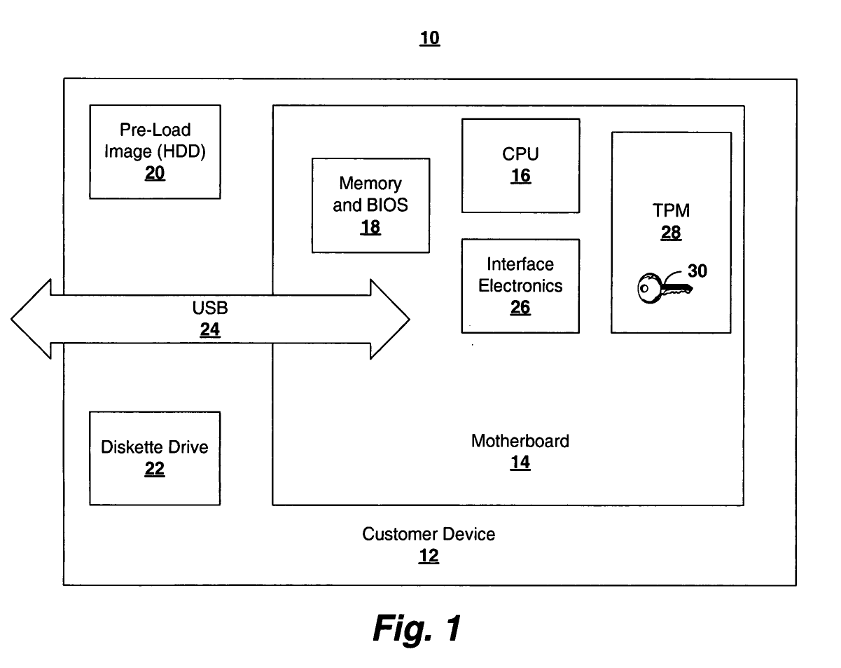

Referring initially to FIG. 1, a computing system is shown, generally designated 10, that includes a customer computing device or platform 12. The customer device 12 can be any suitable computer, e.g., a personal computer or larger, a laptop computer, a notebook computer or smaller, etc.

As shown in FIG. 1, the preferred non-limiting customer device 12 includes a motherboard 14 on which is mounted at least one main central processing unit (CPU) 16 that can communicate with a solid state memory 18 on the motherboard 14. The memory 18 can contain basic input/output system (BIOS) instructions useful for booting the device 12 at start up. Additionally, other storage can be provided external to the motherboard 14, e.g., a hard disk drive 20 (that can hold a pre-load image of the software state of the device 12 upon completion of start up) and a floppy diskette drive 22. Moreover, the CPU 16 can communicate with external devices through a universal serial bus (USB) 24 using interface electronics 26 in accordance with USB principles known in the art.

As intended by the present invention, the customer device 12 can be rendered into a trusted device by the user. To this end, a security module such as a trusted platform module (TPM) 28 is provided on the motherboard 14. The presently preferred non-limiting TPM 28 is a hardware module that is soldered or otherwise affixed to the motherboard 14, i.e., it is not removable from the computer. Among other things, the TPM 28 contains various encryption keys 30, including storage keys, endorsement keys, and so on.

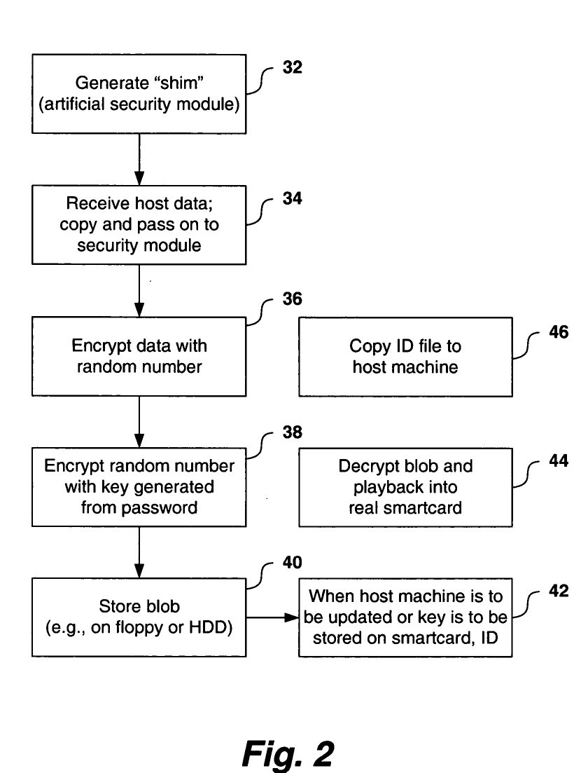

The CPU 16 and/or TPM 28 may access a software-implemented shim as set forth below to permit migrating tokens necessary for logging onto applications and/or application networks and otherwise stored in the TPM 28, which is otherwise not removable from the computing device 12. Now referring to FIG. 2 and commencing at block 32, in one embodiment a shim is generated that is a surrogate or artificial TPM. Specifically, the shim appears to the application as the TPM. The shim is interposed between the application and TPM.

At block 34 host data from the application intended for the TPM is sent to and copied by the shim. The data is then passed on to the TPM. At block 36 the shim encrypts the data with a random number just as the TPM would, and if desired at block 38 the shim also encrypts the random number with a key that is generated by an untypable password, also generated by the shim. The resulting “blob” of data is then stored apart from the TPM, e.g., on a floppy diskette or the hard drive 20.

When it is desired at block 42 to update the customer computing device 12 or the log-on data (e.g., one or more of the key, password, and random number) is to be migrated to a different platform, the logic moves to block 44 to decrypt the blob and send the decrypted blob to a transfer module such as a Smartcard. Then, at block 46 the ID file from the blob on the Smartcard may be copied into the new host computer, to enable logon from the new host computer.

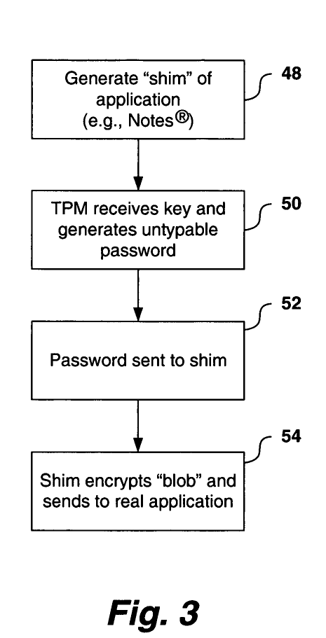

Instead of simulating the TPM, the present shim may instead simulate the application. FIG. 3 illustrates the logic for such an embodiment. Commencing at block 48, the shim of the application is generated, and at block 50 the actual TPM 28 receives the key from the actual application and generates a password, potentially an untypable password. The password is sent to the shim at block 52, which, at block 54, encrypts a data blob and sends the blob to the real application. The blob may be stored and used to migrate the log on token in accordance with principles discussed above.

While the particular SYSTEM AND METHOD FOR MAKING PASSWORD TOKEN PORTABLE IN TRUSTED PLATFORM MODULE (TPM) as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. It is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. §112, sixth paragraph, unless the element is expressly recited using the phrase “means for” or, in the case of a method claim, the element is recited as a “step” instead of an “act”. Absent express definitions herein, claim terms are to be given all ordinary and accustomed meanings that are not irreconcilable with the present specification and file history.

1. A method for promoting the portability of a token, comprising:
establishing a shim, the shim being a surrogate of a security module that is not removable from a customer computing device;
receiving, at the shim, data intended for the security module, the data being recorded at the shim and passed on to the security module;
at the shim, encrypting the data with a random number to render at least a portion of a blob; and
storing the blob on a storage device external to the security module.

2. The method of claim 1, comprising encrypting the random number with a key generated using the password.

3. The method of claim 2, comprising decrypting the blob and passing it to the security module when it is desired to migrate at least one of: the key, the random number, and the password, from the security module to another location.

4. The method of claim 1, wherein the security module is a trusted platform module (TPM).

5. A customer computing device, comprising:
at least one application requiring use of a token to log on to an application network;
at least one permanently mounted security module possessing the token to allow a user of the customer computing device to log on to the network; and
at least one software-implemented shim representative of one of: the application, and the security module, the shim being positioned in a communication path between the application and security module and facilitating migration of the token from the security module under predefined conditions.

6. The device of claim 5, wherein the shim is a surrogate of the security module, the shim including:
means for receiving data from the application and intended for the security module;
means for passing the data on to the security module;
means for encrypting the data with a random number to render at least a portion of a blob; and
means for storing the blob on a storage device external to the security module.

7. The device of claim 6, wherein the shim comprises means for encrypting the random number with a key generated using a password.

8. The device of claim 7, wherein the shim comprises means for decrypting the blob and passing it to the security module when it is desired to migrate at least one of: the key, the random number, and the password, from the security module to another location.

9. The device of claim 6, wherein the shim is a surrogate of the application, the shim receiving from the security module a password and encrypting a data blob with the password and sending the blob to the application.

10. In a system including at least one application requiring use of a token to log on to an application network and at least one permanently mounted security module possessing the token to allow a user to log on to the network, a method for promoting the portability of the token, comprising:
providing a shim, the shim being a surrogate of the application, the shim receiving from the security module a password and encrypting a data blob with the password and sending the blob to the application.

11. A computing device, comprising:
at least one application requiring log on data to access;
at least one permanently mounted security module holding the log on data; and
at least one shim interposed between the application and security module to appear to function as the application or the security module for providing a means for migrating the token if desired by a user.

12. The device of claim 11, wherein the shim is a surrogate of the security module, the shim including:
means for receiving data from the application and intended for the security module;
means for passing the data on to the security module;
means for encrypting the data with a random number to render at least a portion of a blob; and
means for storing the blob on a storage device external to the security module.

13. The device of claim 12, wherein the shim comprises means for encrypting the random number with a key generated using a password.

14. The device of claim 13, wherein the shim comprises means for decrypting the blob and passing it to the security module when it is desired to migrate at least one of: the key, the random number, and the password, from the security module to another location.

15. The device of claim 11, wherein the shim is a surrogate of the application, the shim receiving from the security module a password and encrypting a data blob with the password and sending the blob to the application.
